(19) United States
(12) Patent Application Publication
(10) Pub. No.: US 2013/0316572 A1
(43) Pub. Date: Nov. 28, 2013

(54) CONNECTOR ASSEMBLY

(71) Applicants: Kohki Ishikawa, Tokyo (JP); Shigeru Ishikawa, Sagamihara-shi (JP)

(72) Inventors: Kohki Ishikawa, Tokyo (JP); Shigeru Ishikawa, Sagamihara-shi (JP)

(73) Assignee: FUJIKURA, LTD., Tokyo (JP)

(21) Appl. No.: 13/956,954

(22) Filed: Aug. 1, 2013

Related U.S. Application Data
(63) Continuation of application No. PCT/JP2012/052404, filed on Feb. 2, 2012.

(30) Foreign Application Priority Data
Feb. 4, 2011 (JP) 2011-022954

(51) Int. Cl. H01R 13/621

(52) U.S. Cl. CPC H01R 13/621
USPC 439/569

(57) ABSTRACT

A connector assembly (1) comprises: a female connector (60) which includes a female terminal (70), a female-side housing (80) which holds the female terminal (70), and a bolt (86) which is held to be rotatable by the female-side housing (80); and a male connector (10) which includes a male terminal (20), a male-side housings (30 and 50) which holds the male terminal (20) and can be fitted with the female-side housing (80), and a female screw portion (531) which is provided in the male-side outer housing (50), the female connector (60) and the male connector (10) fit together by screwing the bolt (86) and the female screw portion (531) with each other, and the connector assembly (1) comprise a fitting indicator (514 and 824) which indicates fitting between the female terminal (70) and the male terminal (20).

### TECHNICAL FIELD

The present invention relates to a connector assembly that fits a first connector and a second connector together through bolt fastening.

The present application claims priority from Japanese Patent Application No. 2011-22954 filed on Feb. 4, 2011 and International Application PCT/JP2012/52404 filed on Feb. 2, 2012. The contents described and/or illustrated in the documents relevant to the Japanese Patent Application No. 2011-22954 and International Application PCT/JP2012/52404 will be incorporated herein by reference as a part of the description and/or drawings of the present application.

### BACKGROUND ART

Bolt fastening-type connector assemblies are known which fit a plug connector and a terminal arrangement housing by screwing a bolt into a female screw member (for example, see Patent Document 1).

In such a connector assembly, the bolt is arranged at the center of the plug connector, the female screw member is also arranged at the center of the terminal arrangement housing, and bolt fastening is performed at the center of the connector assembly.

### CITATION LIST

### Patent Document

Patent Document 1: JP 2002-222679 A

### DISCLOSURE OF THE INVENTION

### Problem to be Solved by the Invention

However, in a case where a plurality of electric wires connected to a connector are shielded together by one braided wire or a connector is configured to have a waterproof performance, connectors can not be fastened together by a bolt at the center of the connector assembly, and the connectors have to be fastened together by a bolt at a position deviated from the center.

When the connectors are fastened by the bolt at a deviated position, an asymmetric force is applied to the connectors, and accordingly, galling between the bolt and a female screw portion may easily occur.

When galling between the bolt and the female screw portion occurs, there is a problem in that it cannot be distinguished whether or not terminals appropriately fit together inside the connector assembly.

An object of the present invention is to provide a connector assembly capable of distinguish fitting between terminals.

### Means for Solving Problem

[1] A connector assembly according to the present invention comprising: a first connector including a first terminal, a first connector main body which holds the first terminal, and a bolt which is held to be rotatable by the first connector main body; a second connector including a second terminal which can be fitted with the first terminal, a second connector main body which holds the second terminal and can be fitted with the first connector main body, and a female screw portion which is provided in the second connector main body, and a fitting indicator which indicates fitting between the first terminal and the second terminal, wherein the first connector and the second connector fit together by screwing the bolt and the female screw portion with each other, and the fitting indicator includes: an elastic piece which has a protrusion and which is provided in one of the first connector main body or the second connector main body along a fitting direction of the first terminal and the second terminal; and a concave portion which is provided in other of the second connector main body or the first connector main body and into which the protrusion is inserted.

[2] In the above-described invention, the bolt may be held to be rotatable by the first connector main body at a position deviated from the center of the first connector, and the female screw portion may be also provided in the second connector main body at a position deviated from the center of the second connector so as to correspond to the bolt.

[3] In the above-described invention, the fitting indicator may indicate fitting between the first terminal and the second terminal on the basis of a relative positional relation between the first connector main body and the second connector main body.

[4] In the above-described invention, the other of the second connector main body or the first connector main body may include a rib extending along the fitting direction, and the concave portion may be formed in the rib.

[5] In the above-described invention, it may be configured such that, when the first connector main body and the second connector main body start to fit together, the elastic piece is bent by being pressed by the rib, and, when a relative position between the first connector main body and the second connector main body arrives at a position where the first terminal and the second terminal fit together at a regular position, the protrusion is inserted into the concave portion, and the bending of the elastic piece is released.

[6] In the above-described invention, the one of the first connector main body or the second connector main body may include a frame portion which surrounds at least a part of the elastic piece.

### Effect of the Invention

According to the present invention, the fitting between a first terminal and a second terminal can be distinguished by a fitting indicator.

### BRIEF DESCRIPTION OF DRAWINGS

FIG. 1 is a perspective view that illustrates a connector assembly in an embodiment of the present invention and is a diagram that illustrates the connector assembly in a fitted state;

FIG. 2 is an exploded perspective view that illustrates the connector assembly in an embodiment of the present invention;

FIG. 3(a) is a front view that illustrates a male connector in an embodiment of the present invention, FIG. 3(b) is a plan view that illustrates a male connector in an embodiment of the present invention, FIG. 3(c) is a side view of the male connector in this embodiment, and FIG. 3(d) is a rear view that illustrates the male connector in this embodiment;

FIG. 4 is an exploded perspective view that illustrates a male connector in an embodiment of the present invention;

FIG. 5 is a perspective view that illustrates a partition member in an embodiment of the present invention;

FIGS. 6(a) to 6(e) are diagrams that illustrate the sequence of assembly of a male connector in an embodiment of the present invention;

FIG. 7(a) is a front view that illustrates a female connector in an embodiment of the present invention, FIG. 7(b) is a plan view that illustrates a female connector in an embodiment of the present invention, and FIG. 7(c) is a side view that illustrates a female connector in an embodiment of the present invention;

FIG. 8 is an exploded perspective view that illustrates a female connector in an embodiment of the present invention;

FIGS. 9(a) to 9(c) are enlarged cross-sectional views of a portion IX illustrated in FIG. 7(c), FIG. 9(a) illustrates a state before fitting a male terminal into a female terminal, FIG. 9(b) illustrates a state in which the male terminal and the female terminal are fitted together, and FIG. 9(c) illustrates a state in which the male terminal and the female terminal are half-fitted together;

FIG. 10(a) is an enlarged cross-sectional view taken along line X-X illustrated in FIG. 7(c), and FIG. 10(b) is a cross-sectional view taken along line XB-XB illustrated in FIG. 10(a);

FIGS. 11(a) to 11(g) are diagrams that illustrate the sequence of assembly of a female connector in an embodiment of the present invention;

FIGS. 12(a) to 12(c) are cross-sectional views that illustrate an operation of fitting together a male connector and a female connector in an embodiment of the present invention;

FIG. 13(a) is an enlarged view of a portion XIIIA illustrated in FIG. 12(b), and FIG. 13(b) is an enlarged view of a portion XIIIB illustrated in FIG. 12(c);

FIGS. 14(a) and 14(b) are perspective views corresponding to FIGS. 12(b) and 12(c) respectively;

FIG. 15 is a cross-sectional view that illustrates a first modified example of a fitting indicator in an embodiment of the present invention;

FIG. 16(a) is a cross-sectional view that illustrates a second modified example of the fitting indicator in an embodiment of the present invention, and FIG. 16(b) is an arrow view taken along XVIB illustrated in FIG. 16(a);

FIG. 17 is a cross-sectional view that illustrates a third modified example of the fitting indicator in an embodiment of the present invention; and

FIG. 18 is a plan view that illustrates a fourth modified example of the fitting indicator in an embodiment of the present invention.

### BEST MODE(S) FOR CARRYING OUT THE INVENTION

Hereinafter, embodiments of the present invention will be described with reference to the drawings.

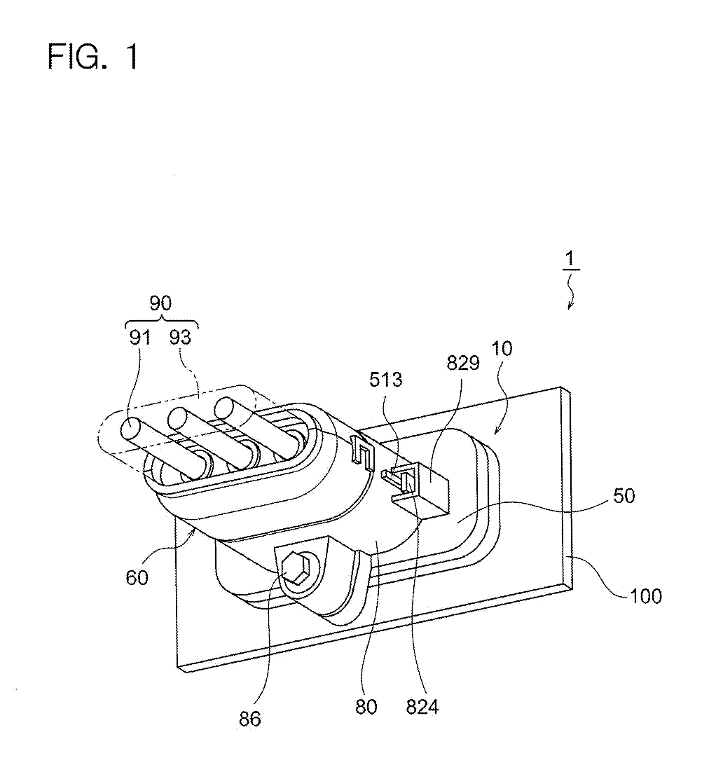

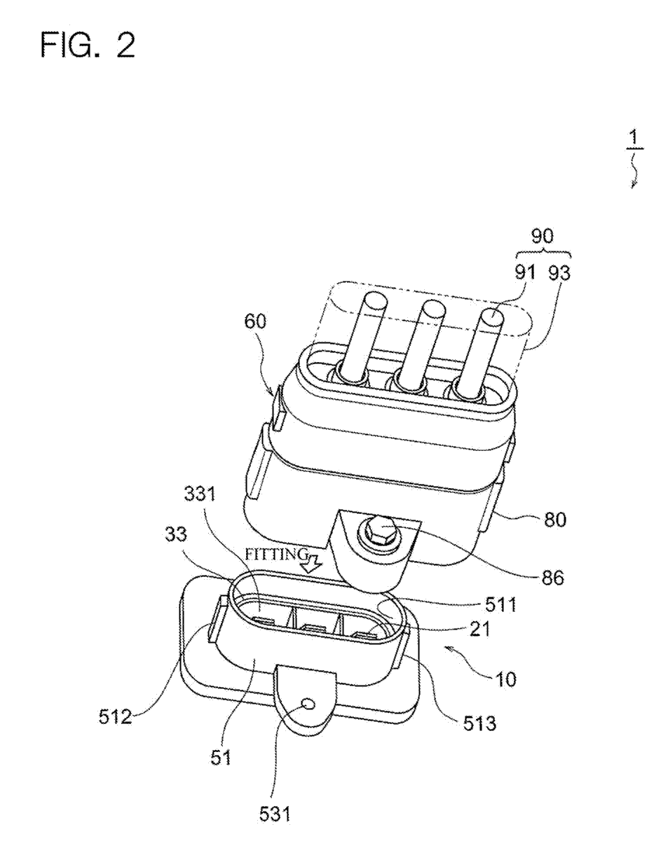

FIGS. 1 and 2 are diagrams that illustrate a connector assembly in this embodiment, FIG. 1 illustrates the connector assembly in a fitted state, and FIG. 2 illustrates the connector assembly before fitting.

The connector assembly 1 in this embodiment, as illustrated in FIGS. 1 and 2, comprises a male connector 10 and a female connector 60 that can be fitted together. For example, in an electric vehicle using an electric motor as a driving source, this connector assembly 1 is used as a connector of electric power cables transferring large-volume electric power between the electric motor and an inverter or between the inverter and a battery.

In this embodiment, the male connector 10, for example, is attached to a casing 100 of the electric motor. On the other hand, the female connector 60, for example, is attached to an end portion of an AC electric power cable 90 that is electrically connected to the inverter.

In this embodiment, the AC power cable 90 comprises three electric wires 91 for three-phase AC power (U, V, and W phases) and a braided wire 93 enclosing the three electric wires 91.

In this connector assembly 1, by screwing (threadably engaging) a bolt 86 provided in the female connector 60 into a female screw portion 531 of the male connector 10, the male connector 10 and the female connector 60 fit together, and the inverter and the electric motor are electrically connected to each other through the electric power cable 90.

Note that, for example, the connector assembly 1 in this embodiment may be used, for example, for connecting a electric power cable electrically connected to an electric motor to an inverter or may be used for electrically connecting an inverter and a battery to each other. Here, the above-described electric vehicle includes a hybrid electric vehicle that uses both an internal combustion engine and an electric motor as a driving source.

Hereinafter, a direction for fitting the male connector 10 and the female connector 60 together will be referred to as a “fitting direction”, and a direction for separating the male connector 10 and the female connector 60 (in other words, a direction opposite to the fitting direction) will be referred to as a “releasing direction”.

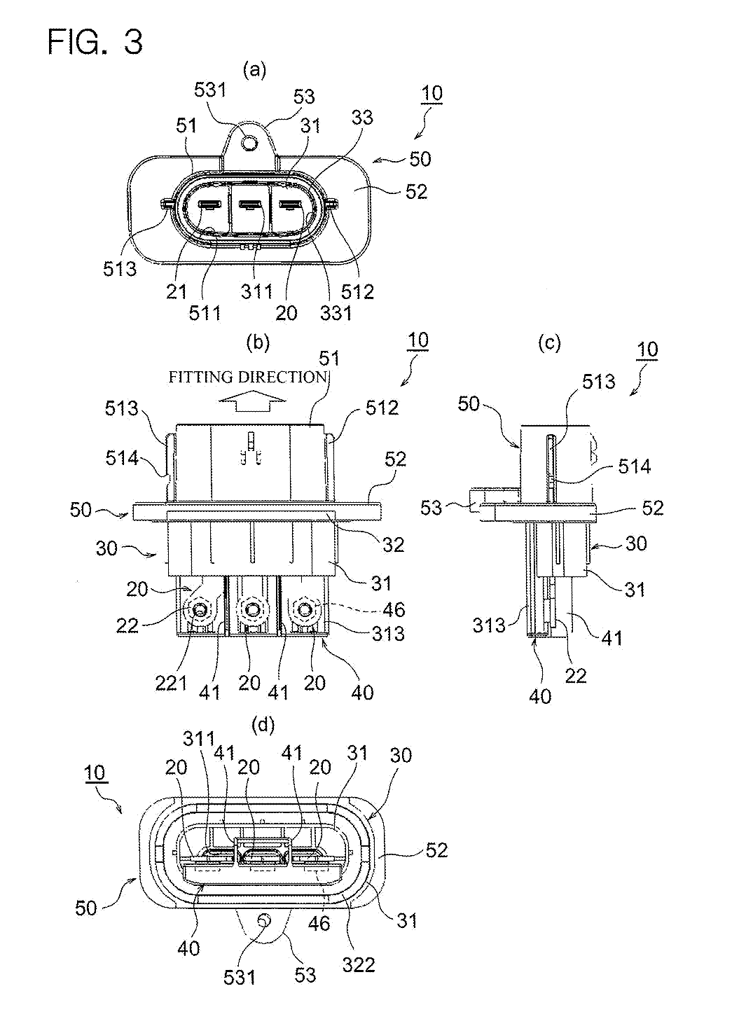

First, the configuration of the male connector 10 will be described in detail with reference to FIGS. 3 to 5.

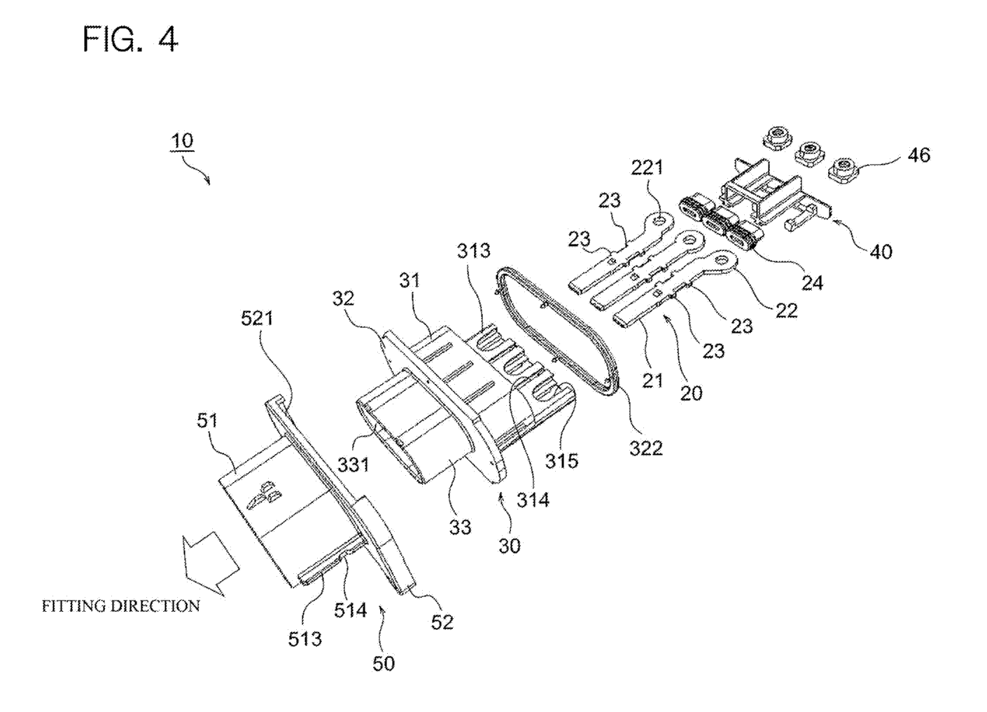

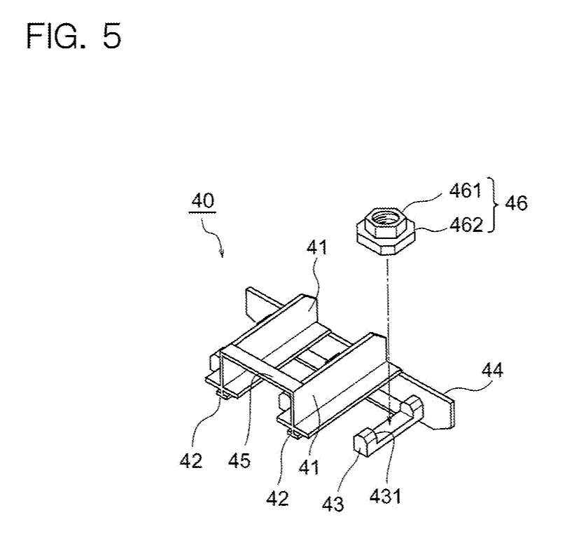

FIGS. 3(a) to 3(d) are diagrams that illustrate the male connector in this embodiment. FIG. 4 is an exploded perspective view that illustrates the male connector in this embodiment. FIG. 5 is a perspective view that illustrates a partition member in this embodiment.

The male connector 10 in this embodiment, as illustrated in FIGS. 3(a) to 3(d) and 4, comprises three male terminal 20, a male-side inner housing 30, a partition member 40, and a male-side outer housing 50.

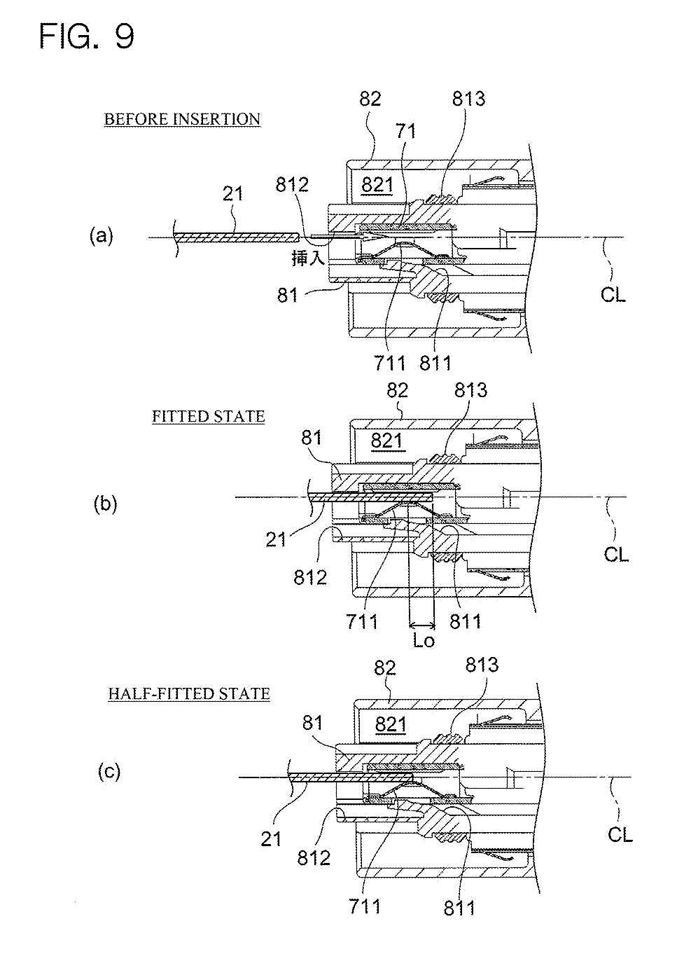

The male terminal 20, for example, is made from copper or a copper alloy and, as illustrated in FIG. 4, includes a flat tab 21 at the front end thereof and includes a circular portion 22 (so-called an LA terminal) having an inner hole 221 at the rear end thereof. By inserting the tab 21 of the male terminal 20 into a housing portion 71 (see FIG. 9(a)) of the female terminal 70, the male terminal 20 and the female terminal 70 fit together.

As illustrated in FIGS. 3(b) and 3(d), on the lower side of the circular portion 22 of the male terminal 20, nuts 46 are held by the partition member 40. For example, by screwing a bolt (not illustrated in the figure) inserted into the inner hole 221 into the nut 46, a busbar (not illustrated in the figure) electrically connected to the electric motor is fastened to the male terminal 20, whereby the busbar and the male terminal 20 are electrically connected to each other.

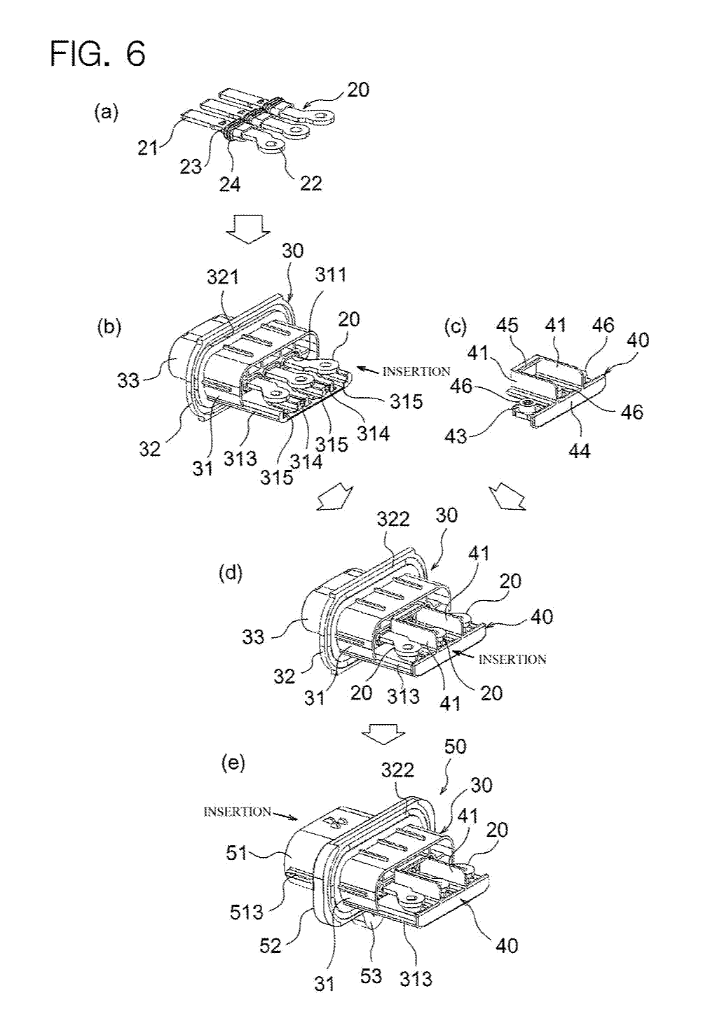

Further, as illustrated in FIG. 4, two sets of protrusions 23 are formed in a middle portion of this male terminal 20. The male terminal 20 is inserted into a circular terminal seal 24 such that the terminal seal 24 is positioned between the protrusions 23 (see FIG. 6(a)), and the terminal seal 24 is held by the protrusions 23. The terminal seal 24, for example, is made from fluoride rubber.

The male-side inner housing 30, as illustrated in FIGS. 3(a) to 3(d) and 4, includes a terminal holding portion 31, an inner flange 32, and a male-side inner cylinder portion 33. The male-side inner housing 30, for example, is made from a material having electric insulation such as a resin material, and the terminal holding portion 31, the inner flange 32, and the male-side inner cylinder portion 33 are integrally formed.

In the terminal holding portion 31, three terminal holding holes 311 that holds the male terminals 20 are formed to be substantially parallel to each other. Each terminal holding hole 311 passes through the terminal holding portion 31, and the male terminal 20 is inserted into the inside of the terminal holding hole 311 from the tab 21 side through an opening disposed on the releasing direction side. Further, the terminal seal 24 is pressed into this terminal holding hole 311 together with the male terminal 20, and the terminal seal 24 seals between the male terminal 20 and the male-side inner housing 30.

The tab 21 of the male terminal 20 inserted into the terminal holding hole 311 protrudes from the opening of the terminal holding hole 311 that is disposed on the fitting-direction side and is positioned inside an inner hole 331 of the male-side inner cylinder portion 33.

On the other hand, the circular portion 22 of the male terminal 20 also protrudes from the opening of the terminal holding hole 311 that is disposed on the releasing-direction side, but the lower portion of the terminal holding portion 31 extends to the lower side of the circular portion 22 to configure an extending portion 313. An insertion groove 314 into which a first support arm 42 of the partition member 40 is inserted and a cutout 315 into which a second support arm 43 and a nut 46 are inserted are formed in this extending portion 313.

The inner flange 32 spreads from the terminal holding portion 31 in the diameter direction, and, on the principal face of the inner flange 32 that is disposed on the releasing-direction side, a circular groove 321 (see FIG. 6(b)) is formed so as to surround the terminal holding portion 31. A housing seal 322, for example, made from a fluororubber or the like is inserted in this circular groove 321.

The male-side inner cylinder portion 33 protrudes from the inner flange 32 toward the fitting direction. This male-side inner cylinder portion 33 is an approximately flat cylindrical body which has the inner hole 331, and the tab 21 of the male terminal 20 protruding from the terminal holding portion 31 is located in the inner hole 331.

The partition member 40, as illustrated in FIG. 5, includes two ribs 41, two first support arms 42, three second support arms 43, a first connection bar 44, and a second connection bar 45. This partition member 40, for example, is made from a material having electric insulation such as a resin material, and the rib 41, the first support arms 42, the second support arms 43, the first connection bar 44, and the second connection bar 45 are integrally formed.

The two ribs 41 are respectively supported by the first support arms 42. The two first support arms 42 are connected together at the releasing-direction side end portions via the first connection bar 44, and are connected together at the fitting-direction side end portions via the second connection bar 45.

The three second support arms 43 protrude from the first connection bar 44 in the fitting direction. These three second support arms 43 are arranged so as to correspond to the circular portions 22 of three male terminals 20 held by the male-side inner housing 30. Further, a concave portion 431 that holds the nut 46 is formed in each second support arm 43. The nut 46 includes a main body portion 461 having a hexagonal external shape and a pedestal portion 462 having an approximately rectangular external shape, and the pedestal portion 462 fits into the concave portion 431 of the second support arm 43.

The first support arm 42 of the partition member 40 is inserted into the insertion groove 314 of the extending portion 313, and the second support arm 43 of the partition member 40 and the nut 46 are inserted into the cutout 315 of the extending portion 313.

In this way, when the partition member 40 is inserted into the male-side inner housing 30, as illustrated in FIGS. 3(b) and 3(d), the rib 41 is interposed as a partition wall between the male terminals 20, whereby a creepage distance of insulation between the male terminals 20 is secured.

Further, when the circular portion 22 of the male terminal 20 and the busbar are fastened by the bolt and the nut 46, the whole partition member 40 including the nut 46 is fixed to the male-side inner housing 30 though the male terminal 20 and the bolt.

The male-side outer housing 50, as illustrated in FIGS. 3(a) to 3(d) and 4, includes a male-side outer cylinder portion 51, an outer flange 52, and a male-side convex portion 53. This male-side outer housing 50, for example, is made from a material having conductivity such as aluminum, and the male-side outer cylinder portion 51, the outer flange 52, and the male-side convex portion 53 are integrally formed.

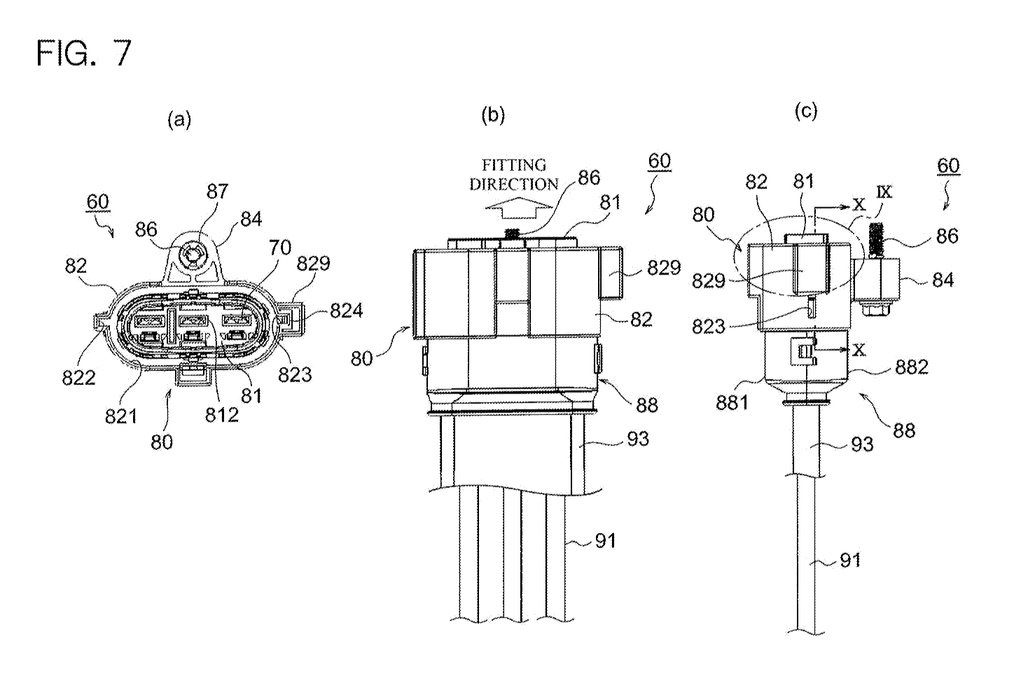

The male-side outer cylinder portion 51 is an approximately flat cylindrical body which has the inner hole 511, and the male-side inner cylinder portion 33 is inserted in the inner hole 511. Further, at both ends of the male-side outer cylinder portion 51 in the major axis direction, guide ribs 512 and 513 are formed along the fitting direction. When the male connector 10 and the female connector 60 fit together, by guiding the guide ribs 512 and 513 into guide grooves 822 and 823 (see FIG. 7(a)) of the female connector 60, the female connector 60 is precisely positioned with respect to the male connector 10.

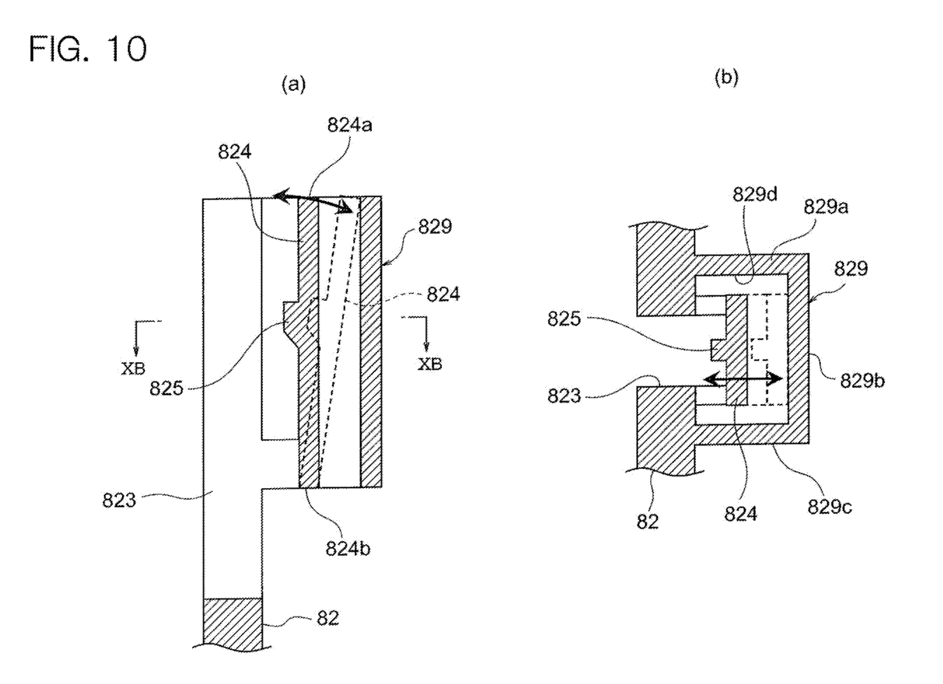

Further, in this embodiment, as illustrated in FIG. 3(b), a concave portion 514 into which a protrusion 825 (see FIG. 10(a)) of an elastic piece 824 of the female connector 60 inserts is formed in one guide rib 513.

The outer flange 52 is provided on the releasing-direction side end portion of the male-side outer cylinder portion 51. As illustrated in FIG. 4, a concave portion 521 corresponding to the inner flange 32 of the male-side inner housing 30 is formed in the outer flange 52, and the inner flange 32 is fitted into the concave portion 521. This outer flange 52 is fastened to the casing 100 of the electric motor by using a bolt or the like.

The male-side convex portion 53 protrudes from the male-side outer cylinder portion 51 in the diameter direction. As illustrated in FIGS. 3(a) and 3(d), a female screw portion 531 that can be screwed with the bolt 86 of the female connector 60 is provided in the approximate center of the male-side convex portion 53. The female screw portion 531 is arranged at a position deviated from a fitting plane CL as a center, the fitting plane CL (see FIGS. 9(a) to 9(c)) is a plane in which the male terminal 20 and the female terminal 70 fit together, and the female screw portion 531is provided at an outer periphery portion of the male-side outer housing 50. This female screw portion 531, for example, is configured by embedding a nut in the male-side outer housing 50.

Hereinafter, the sequence of assembly of the male connector 60 will be described with reference to FIGS. 6(a) to 6(e). FIGS. 6(a) to 6(e) are diagrams that illustrate the sequence of assembly of a male connector in this embodiment.

First, as illustrated in FIG. 6(a), the male terminal 20 is inserted into the terminal seal 24, and the terminal seal 24 is positioned between the protrusions 23. Subsequently, as illustrated in FIG. 6(b), the male terminal 20 is inserted into the terminal holding hole 311 of the male-side inner housing 30.

Meanwhile, as illustrated in FIG. 6(c), nuts 46 are fitted into concave portions 431 of the second support arm 43 of the partition member 40.

Subsequently, as illustrated in FIG. 6(d), the first support arm 52 of the partition member 40 is inserted into the insertion groove 314 of the male-side inner housing 30, and the second support arm 43 of the partition member 40 and nuts 46 are inserted into the cutout 315 of the male-side inner housing 30, whereby the partition member 40 is assembled into the male-side inner housing 30. Further, the housing seal 36 is fitted into the circular groove 34 of the male housing 20.

Subsequently, as illustrated in FIG. 6(e), the male-side inner cylinder portion 33 is inserted into the male-side outer cylinder portion 42, and the inner flange 32 is fitted into the concave portion 521 of the outer flange 52, and the male-side inner housing 30 is assembled into the male-side outer housing 50, whereby the male connector 10 is completed.

Next, the configuration of the female connector 60 will be described in detail with reference to FIGS. 7 to 10.

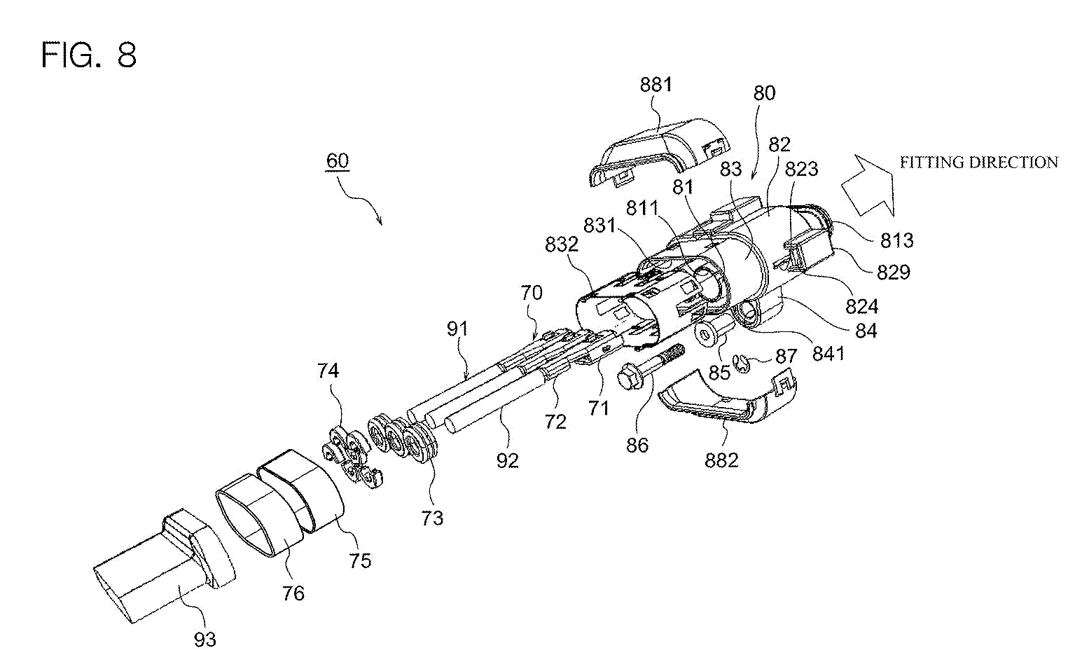

FIGS. 7(a) to 7(c) are diagrams that illustrate the female connector in this embodiment, FIG. 8 is an exploded perspective view of the female connector in this embodiment, FIGS. 9(a) to 9(c) are enlarged cross-sectional views of a portion IX illustrated in FIG. 7(c), FIG. 10(a) is an enlarged cross-sectional view taken along line X-X illustrated in FIG. 7(c), and FIG. 10(b) is a cross-sectional view taken along line XB-XB illustrated in FIG. 10(a).

The female connector 60 in this embodiment, as illustrated in FIGS. 7(a) to 7(c) and 8, includes three female terminals 70 and a female-side housing 80.

The female terminal 70, for example, is made from copper or a copper alloy and, as illustrated in FIG. 8, includes an approximate box-shaped housing portion 71 at the front end side thereof and includes a barrel portion 72 at the rear end thereof.

As illustrated in FIG. 9(a), a flat spring member 711 bent in an arch shape is provided inside the housing portion 71 of the female terminal 70. The tab 21 of the male terminal 20 can be inserted into this housing portion 71, and the tab 21 inserted into the inside of the housing portion 71 is pressed to the inner wall face of the box-shaped housing portion 71 by the flat spring member 711. Accordingly, the tab 21 is inserted into the inside of the housing portion 71 while being pressed by the flat spring member 711. In accordance with the pressing, wiping is performed for the tab 21 and the housing portion 71 with each other, and an oxide film formed on the surface of the tab 21 and the housing portion 71 is removed.

In this embodiment, as illustrated in FIG. 9(b), when the tab 21 inserted into the housing portion 71 arrives at a regular position, the male terminal 20 and the female terminal 70 are completely fitted together. Here, the regular position is a position at which the tab 21 is in friction with the housing portion 71 by a predetermined distance L₀ and does not include a position (half-fitting) at which the male terminal 20 and the female terminal 70 are only in contact with each other and a predetermined amount L₀ of wiping is not secured as illustrated in FIG. 9(c).

As illustrated in FIG. 8, a center conductor of the electric wire 91 of the electric power cable 90 is crimped to the barrel portion 72 of the female terminal 70. Note that, while this electric wire 91 includes an insulating layer 92 covering the outer circumference of the center conductor, the coated layer 92 is peeled off and the center conductor is exposed at the end portion that is crimped to the barrel portion 72.

This electric wire 91 is inserted into a circular wire seal 73. Further, a strain reef 74 is attached to the electric wire 91 near the wire seal 73, and the detachment of the wire seal 74 is prevented. Note that, for example, the wire seal 73 is made from silicone rubber, and the strain reef 74, for example, is made from polybutylene terephthalate (PBT).

The female-side housing 80, as illustrated in FIGS. 7(a) to 7(c) and 8, includes a terminal housing portion 81, a female-side cylinder portion 82, an outer wall portion 83, and a female-side convex portion 84. This female-side inner housing 80, for example, is made from a material having electric insulation such as a resin material.

In the terminal housing portion 81, three terminal housing holes 811 each housing the female terminals 70 are formed to be substantially parallel to each other. Each terminal housing hole 811 is open on the releasing-direction side, and the female terminal 70 is inserted into the inside of the terminal housing hole 811 from the housing portion 71 side through the opening portion. A wire seal 73 is pressed into the terminal housing hole 811 together with the female terminal 70, and the wire seal 73 seals between the female terminal 70 and the female-side housing 80.

As illustrated in FIG. 9(a), a terminal exposing hole 812 is formed at the bottom of the terminal housing hole 811, and the tab 21 of the male terminal 20 can approach the female terminal 70 housed inside the terminal housing hole 811 through the terminal exposing hole 812.

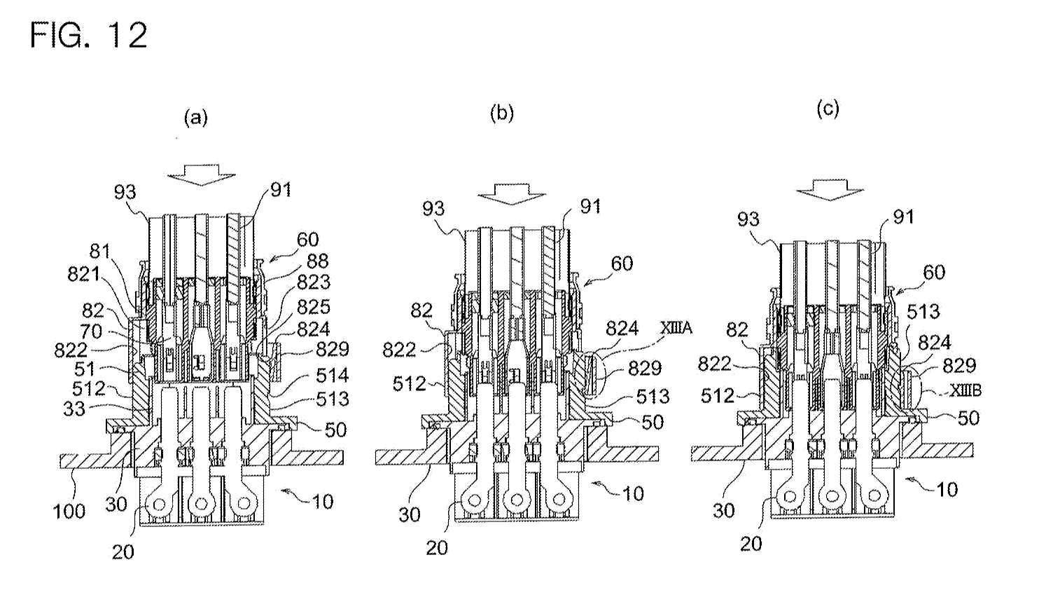

This terminal housing portion 81 protrudes to the inside of the female-side cylinder portion 82, and a fitting groove 821 is formed between the terminal housing portion 81 and the female-side cylinder portion 82. The male-side inner cylinder portion 33 and the male-side outer cylinder portion 51 of the male connector 10 are inserted into this fitting groove 821 and the terminal housing portion 81 is inserted into the inside of the male-side inner cylinder portion 33 and the male-side outer cylinder portion 51, whereby the male connector 10 and the female connector 60 fit together (see FIGS. 12(a) to 12(c)).

Further, in the fitting groove 821, a circular housing seal 813 is installed to the outer periphery of the terminal housing portion 81. This housing seal 813, for example, is made from silicone rubber and seals between the male-side inner cylinder portion 33 and the terminal housing portion 81 at the time of fitting.

The female-side cylinder portion 82, as illustrated in FIG. 7(a), is an approximately flat cylindrical body, and guide grooves 822 and 823 are formed along the fitting direction at both ends of the female-side cylinder portion 82 in the major axis direction. By inserting the guide ribs 512 and 513 of the male connector 10 into the guide grooves 822 and 823, the female connector 60 is precisely positioned with respect to the male connector 10.

Further, the female-side cylinder portion 82 in this embodiment, as illustrated in FIGS. 10(a) and 10(b), includes an elastic piece 824 and a frame portion 829 that are provided to be substantially parallel to one guide groove 823.

While an end portion 824a of the elastic piece 824 on the fitting-direction side is a free end that is not fixed to the female-side cylinder portion 82, an end portion 824b on the releasing-direction side is a fixed end that is connected to the female-side cylinder portion 82. Further, a protrusion 825 inserted into the concave portion 514 formed in one guide rib 513 of the female connector 60 is formed in this elastic piece 824.

In this embodiment, it is configured such that the protrusion 824 of the elastic piece 823 is inserted into the concave portion 514 when the positional relation between the male-side outer housing 50 and the female-side housing 80 is positional relation where the male terminal 20 and the female terminal 70 fit together at a regular position (more accurately, the tab 21 and the housing portion 71 are in friction with each other by a predetermined amount L₀ or more).

On the other hand, the frame portion 829 surrounds the elastic piece 824 with three faces 829a, 829b, and 829c, and the elastic piece 824 can be visually recognized through an opening 829d disposed in the upper portion. In this embodiment, while the frame portion 829 surrounds the whole elastic piece 824 in the longitudinal direction, the configuration is not limited thereto, and the frame portion 829 may surround at least the free end 824a of the elastic piece 824.

The outer wall portion 83, as illustrated in FIG. 8, surrounds the periphery of the terminal housing portion 81 on the releasing-direction side. An approximately flat cylindrical shield plate 832 is inserted in an insertion space 831 formed between the outer wall portion 83 and the terminal housing portion 81. This shield plate 832, for example, is made from copper or a copper alloy and electromagnetically shields the female terminal 70 in the female-side housing 80.

Further the braided wire 93 of the electric power cable 90 and two ferrules 75 and 76 that sandwich an end portion of the braided wire 93 and are crimped are inserted in this insertion space 831. Accordingly, the shield plate 832 and the braided wire 93 are electrically connected to each other through the outer ferrule 75. Then, in the state where the braided wire 93, the ferrules 75 and 76, and the shield plate 832 are inserted into the insertion space 831, the outer wall portion 83 is covered with a rear cover 88 that is configured by an upper cover 881 and a lower cover 882.

The female-side convex portion 84 protrudes from the female-side cylinder portion 82 in the diameter direction at a position corresponding to the male-side convex portion 53. A through hole 841 which passes through the female-side convex portion 84 in the fitting direction is formed in this female-side convex portion 84. The through hole 841 of the female-side convex portion 84 is arranged at a position deviated from the fitting plane CL as a center so as to correspond to the above-described female screw portion 531, the fitting plane CL (see FIGS. 9(a) to 9(c)) is a plane in which the male terminal 20 and the female terminal 70 fit together. A collar 85, for example made of steel, is inserted into this through hole 841, the bolt 86 is further inserted into the collar 85, and, as a result, the bolt 86 is also arranged at a position deviated from the fitting plane CL as a center and is held in the outer periphery of the female-side housing 80. The bolt 86 is prevented from detaching on the face of the female-side convex portion 84 that is located on the fitting-direction side by using an E ring 87 and is held to be rotatable by the female-side housing 80.

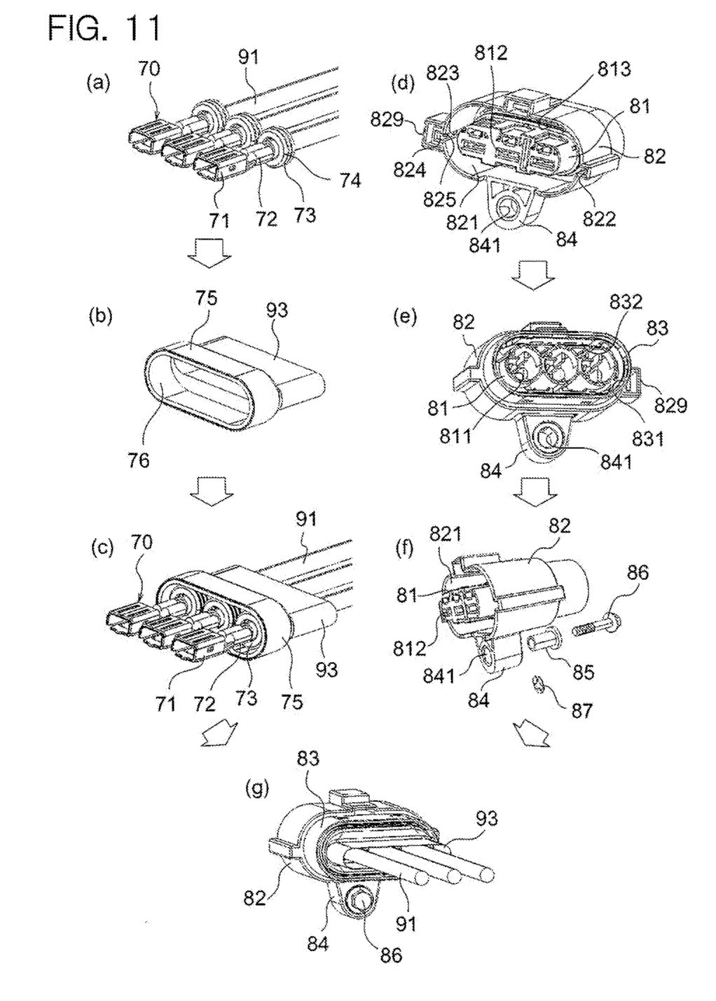

Hereinafter, the sequence of assembly of the female connector 60 will be described with reference to FIGS. 11(a) to 11(g). FIGS. 11(a) to 11(g) are diagrams that illustrate the sequence of assembly of the female connector in this embodiment.

First, as illustrated in FIG. 11(a), the electric wire 91 is inserted into the wire seal 73, and the strain reef 74 is installed to the electric wire 91. Subsequently, the center conductor exposed from the insulating layer 92 at the end portion of the electric wire 91 and the barrel portion 72 of the female terminal 70 are caulked (crimped) each other.

Meanwhile, as illustrated in FIG. 11(b), the end portion of the braided wire 93 is inserted into the inside of the outer ferrule 75, the inner ferrule 76 is inserted into the inside of the end portion of the braided wire 93, the end portion of the braided wire 93 is interposed between the outer ferrule 75 and the inner ferrule 76, and the outer ferrule 75, the braided wire 93, and the inner ferrule 76 are caulked (crimped) each other.

Subsequently, as illustrated in FIG. 11(c), the electric wire 91 to which the female terminal 70 is attached is inserted into the inside of the braided wire 93.

Meanwhile, as illustrated in FIG. 11(d), the housing seal 813 is inserted into the fitting groove 821 of the female-side housing 80, and the housing seal 813 is installed to the periphery of the terminal housing portion 81. Subsequently, as illustrated in FIG. 11(e), the shield plate 832 is inserted into the insertion space 831 of the female-side housing 80. Subsequently, as illustrated in FIG. 11(f), the collar 85 and the bolt 86 are inserted into the through hole 841 of the female-side convex portion 84 of the female-side housing 80, and the bolt 86 is further fixed by the E ring 87.

Subsequently, as illustrated in FIG. 11(g), the female terminal 70 is inserted into the inside of the terminal housing hole 811 of the female-side housing 80, and the outer ferrule 75, the braided wire 93, and the inner ferrule 76 are inserted into the inside of the housing space 831 of the female-side housing 80.

Subsequently, although not particularly illustrated in the figure, by installing the rear cover 88 to the female-side housing 80 so as to cover the outer wall portion 83 of the female-side housing 80 and the braided wire 93, the female connector 60 is completed.

The fitting operation of the above-described male connector 10 and female connector 60 will be described with reference to FIGS. 12(a) to 14(b).

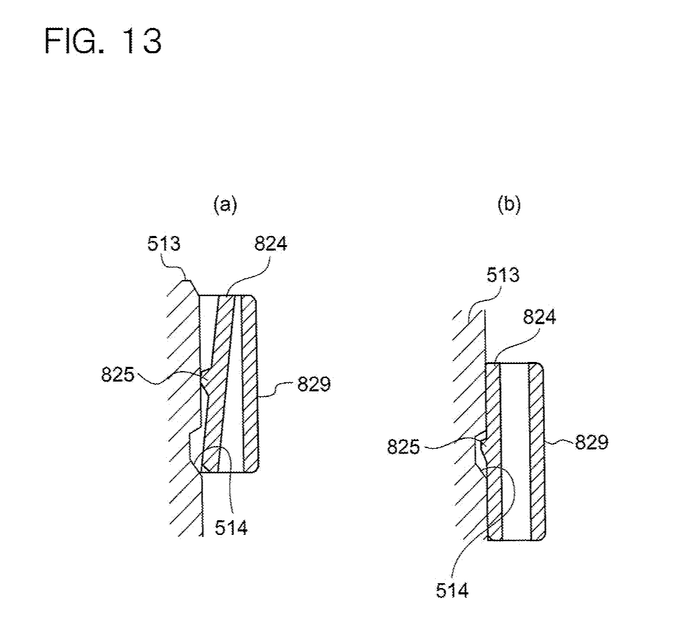

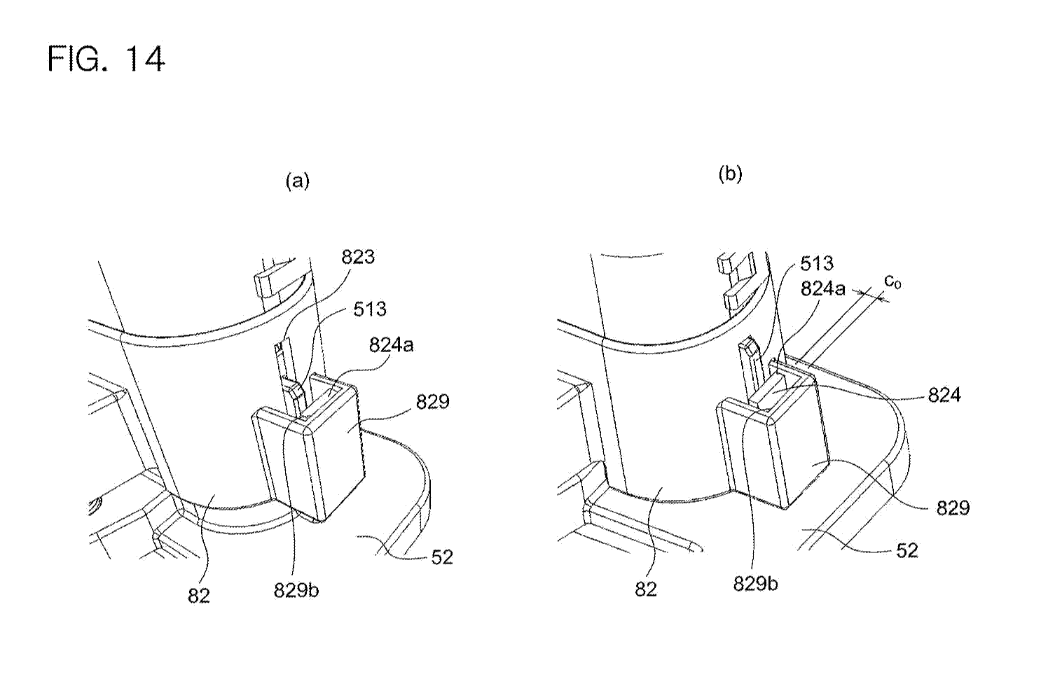

FIGS. 12(a) to 12(c) are cross-sectional views that illustrate the fitting operation of the male connector and the female connector in this embodiment, FIG. 13(a) is an enlarged view of a portion XIIIA illustrated in FIG. 12(b), and FIG. 13(b) is an enlarged view of a portion XIIIB illustrated in FIG. 12(c), and FIGS. 14(a) and 14(b) are perspective views corresponding to FIGS. 12(b) and 12(c).

First, as illustrated in FIG. 12(a), the male connector 10 and the female connector 60 are provisionally fitted together. Thereby, the male-side inner cylinder portion 33 and the male-side outer cylinder portion 51 of the male connector 10 are inserted into the inside of the fitting groove 821 of the female connector 60, and the terminal housing portion 81 of the female connector 60 is inserted into the inside of the male-side inner cylinder portion 33 and the male-side outer cylinder portion 51 of the male connector 10.

At this time, the guide ribs 512 and 513 of the male connector 10 are inserted into the concave portions 822 and 823 of the female connector 60. Further, although particularly not illustrated in the figure, the front end of the male screw portion of the bolt 86 of the female connector 60 is engaged into the female screw portion 531 of the male connector 10, and the bolt 86 can be screwed into the female screw portion 531.

From the state, when the bolt 86 is screwed into the female screw portion 531 by rotating the bolt 86, as illustrated in FIG. 12(b), the female connector 60 approaches the male connector 10 while being guided by the guide ribs 512 and 513 and the concave portions 822 and 823.

In this state, as illustrated in FIG. 13(a), the protrusion 825 of the elastic piece 824 of the female connector 60 is pressed by the guide rib 513 of the male connector 10 so as to transform the elastic piece 824. Accordingly, as illustrated in FIG. 14(a), the free end 824a of the elastic piece 824 is brought into contact with the face 829b of the frame portion 829.

When the bolt 86 is screwed into the female screw portion 531 by further rotating the bolt 86, as illustrated in FIG. 12(c), the female connector 60 further approaches the male connector 10, the male terminal 20 and the female terminal 60 fit together at a regular position, and the male connector 10 and the female connector 60 completely fit together.

In this state, as illustrated in FIG. 13(b), the protrusion 825 of the elastic piece 824 is inserted into the concave portion 514 of the guide rib 513, and accordingly, the elastic piece 824 is restored to be in an upright state by an elastic force. Accordingly, as illustrated in FIG. 14(b), a predetermined gap c₀ is formed between the free end 824a of the elastic piece 824 and the face 829b of the frame portion 829.

As above, in this embodiment, it can be distinguished whether or not the male terminal 20 and the female terminal 70 fit together at the regular position on the basis of the position of the free end 824a of the elastic piece 824. Accordingly, even in the case of the connector assembly of a type being fastened by a bolt at a deviated position, the fitting between the terminals 20 and 70 can be distinguished.

Particularly, in a case where the connectors 10 and 60 fit together inside a narrow area such as the inside of an electric vehicle, only one bolt used for connector fitting is arranged at a position deviated from the fitting face, a probability of the occurrence of galling further increases, and accordingly, the distinguishing of fitting between the terminals 20 and 70 is effective.

Further, in this embodiment, since the frame portion 829 surrounds the periphery of the free end 824a of the elastic piece 824, the fitting between the terminals 20 and 70 can be easily distinguished on the basis of a relative position (the predetermined gap c₀) of the free end 824a with respect to the frame portion 829.

Furthermore, in this embodiment, since the frame portion 829 surrounds the whole elastic piece 824, the elastic piece 824 can be protected.

In addition, in this embodiment, since the elastic piece 824 used for indicating the fitting state between the male terminal 20 and the female terminal 70 is formed to be integrally with the female-side housing 80, there is no increase in the number of components of the female connector 60.

Similarly, in this embodiment, since the concave portion 514 used for indicating the fitting state between the male terminal 20 and the female terminal 70 is formed in one guide rib 513 of the male-side outer housing 50, there is no increase in the number of components of the male connector 10.

Note that, the female connector 60 in this embodiment is equivalent to an example of the first connector in the present invention, the female terminal 70 in this embodiment is equivalent to an example of the first terminal in the present invention, and the female-side housing 80 in this embodiment is equivalent to an example of the first connector main body in the present invention.

Further, the male connector 10 in this embodiment is equivalent to an example of the second connector in the present invention, the male terminal 20 in this embodiment is equivalent to an example of the second terminal in present invention, and the male-side housing 30 and 50 in this embodiment is equivalent to an example of a second connector main body in the present invention, and the fitting plane CL in this embodiment is equivalent to an example of the center of the first and second connectors in the present invention.

Furthermore, the concave portion 514 and the elastic piece 824 in this embodiment are equivalent to one example of the fitting indicator in the present invention.

Note that, the configuration of the fitting indicator that indicates the fitting state between the male terminal 20 and the female terminal 70 is not particularly limited to the above-described configuration. Hereinafter, a modified example of the fitting indicator will be described.

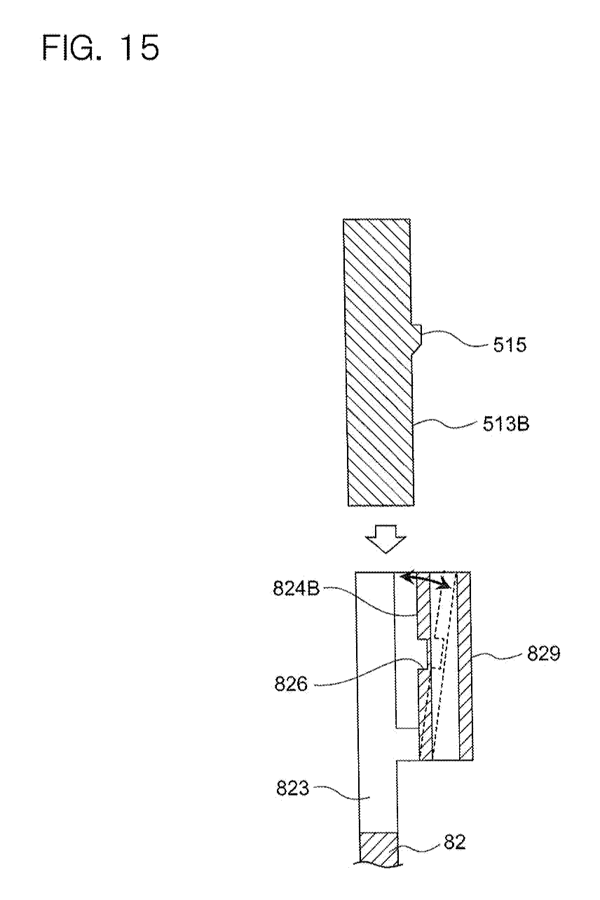

FIG. 15 is a diagram that illustrates a first modified example of the fitting indicator in this embodiment.

As illustrated in FIG. 15, to the contrary to the above-described configuration illustrated in FIG. 10(a), a protrusion 515 may be formed in the guide rib 513B of the male-side outer housing 50, and a concave portion 826 into which the protrusion 515 is inserted my be formed in an elastic piece 824B of the female-side housing 80.

The protrusion 515 and the elastic piece 824B in this example are equivalent to an example of the fitting indicator in the present invention.

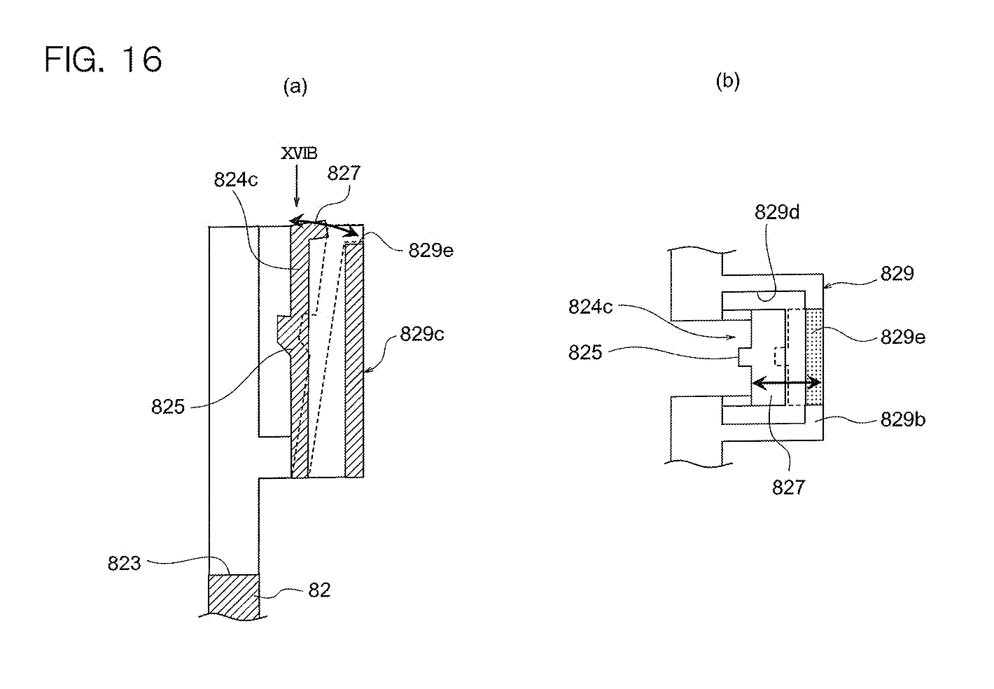

FIG. 16(a) is a diagram that illustrates a second modified example of the fitting indicator in this embodiment, and FIG. 16(b) is an arrow view taken along XVIB illustrated in FIG. 16(a).

As illustrated in FIGS. 16(a) and 16(b), a protruded portion 827 may be provided at the free end of an elastic piece 824C, a cutout 829e may be formed at the upper portion of the face 829b of the frame portion 829C, and the cutout 829e may be colored in red or the like.

When the elastic piece 824C is elastically transformed, the protruded portion 827 covers the cutout 829e, and accordingly, the colored portion cannot be visually recognized. In contrast to this, when the elastic piece 824C is restored to the upright state, the protruded portion 827 separates from the cutout 829e, and accordingly, the colored portion can be visually recognized. Therefore, the fitting state between the terminals 20 and 70 can be distinguished in a further easy manner.

The concave portion 514 and the elastic piece 824C in this example are equivalent to an example of the fitting indicator in the present invention.

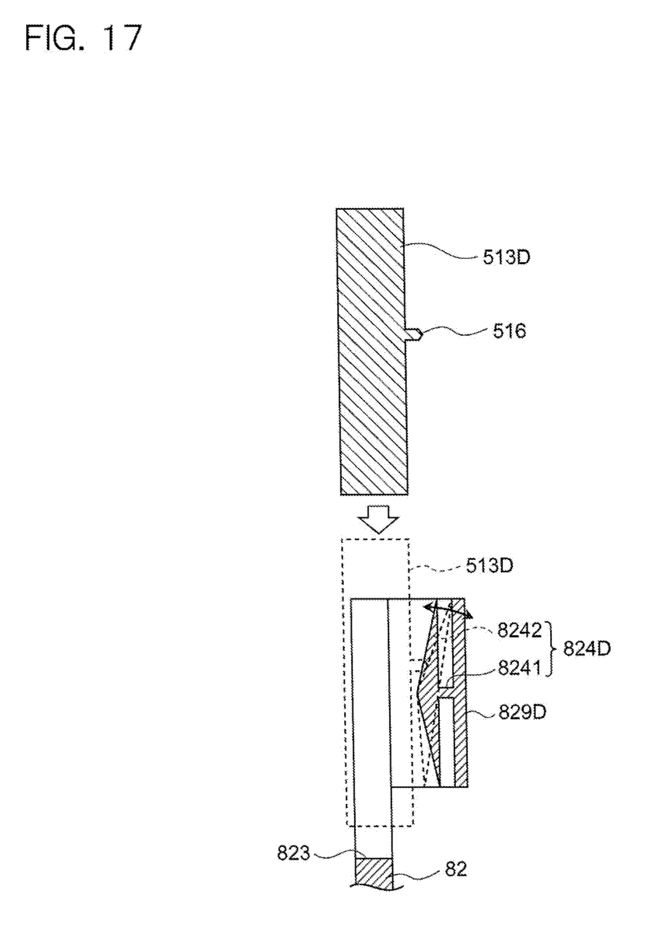

FIG. 17 is a diagram that illustrates a third modified example of the fitting indicator in this embodiment.

As illustrated in FIG. 17, an elastic piece 824D of the female-side housing 80 may be configured by a support portion 8241 provided upright on the frame portion 829D and a cap portion 8242 supported by the support portion 8241. The cap portion 8242 has a triangle pole shape having a ridgeline along a direction perpendicular to the fitting direction. When being pressed by the protrusion 516 of the guide rib 513D, the cap portion 8242 of the elastic piece 824D can oscillate with the support portion 8241 used as a point of support. Accordingly, the fitting state between the terminals 20 and 70 can be distinguished on the basis of the relative distance between the outer periphery portion of the elastic piece 824D and the frame portion 829D.

The protrusion 516 and the elastic piece 824D in this example are equivalent to an example of the fitting indicator in the present invention.

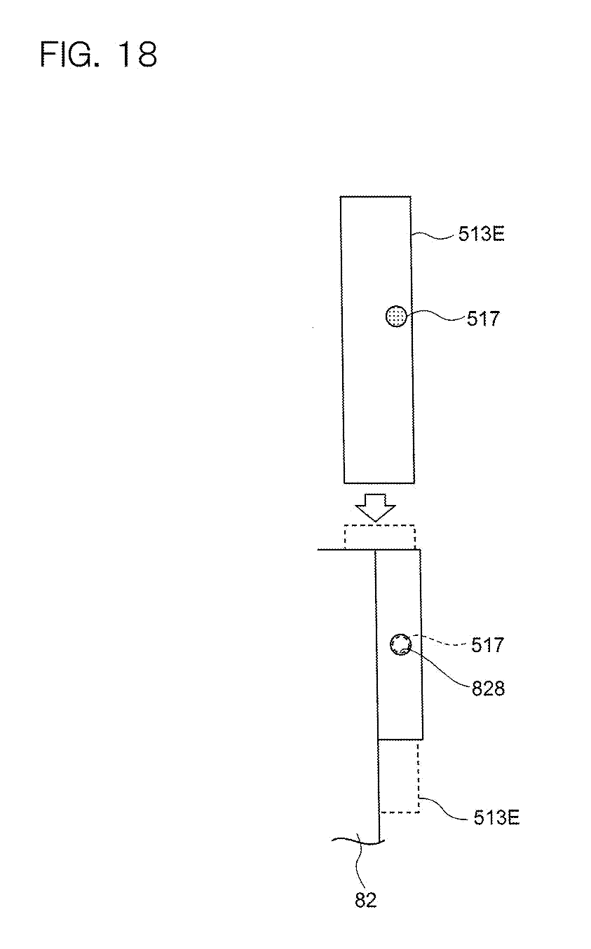

FIG. 18 is a diagram that illustrates a fourth modified example of the fitting indicator in this embodiment.

As illustrated in FIG. 18, instead of the elastic piece, a mark 517 of a red color or the like may be added to a guide rib 513E of the male-side outer housing 50 and a distinguishing hole 828 may be formed in the female-side cylinder portion 82 of the female-side housing 80. The fitting state between the terminals 20 and 70 can be distinguished on the basis of whether or not there is the mark 517 inside the distinguishing hole 828.

The mark 517 and the distinguishing hole 828 in this example are equivalent to an example of the fitting indicator in the present invention.

The embodiments described above have been described for easy understanding of the present invention and not for purposes of limitation of the present invention. Thus, each element disclosed in the above-described embodiments is with intent to include all changes in the design and equivalents thereof belonging to the technical scope of the present invention.

For example, in the above-described embodiment, while the female screw portion 531 is provided in the male connector 10, and the bolt 86 is provided in the female connector 60, the present invention is not limited thereto. For example, the male connector may include a bolt, and the female connector may include a female screw portion.

Further, in the above-described embodiment, while the male connector 10 is attached to the casing 100 of the electric motor, and the female connector 60 is attached to the end portion of the electric power cable 90, the present invention is not limited thereto. For example, the female connector may be attached to the casing of the electric motor, and the male connector may be attached to the electric power cable.

### EXPLANATIONS OF LETTERS OR NUMERALS

1 CONNECTOR ASSEMBLY

10 MALE CONNECTOR

20 MALE TERMINAL

30 MALE-SIDE INNER HOUSING

40 PARTITION MEMBER

50 MALE-SIDE OUTER HOUSING

51 MALE-SIDE OUTER CYLINDER PORTION

513 GUIDE RIB

514 CONCAVE PORTION

53 MALE-SIDE CONVEX PORTION

531 FEMALE SCREW PORTION

60 FEMALE CONNECTOR

70 FEMALE TERMINAL

80 FEMALE-SIDE HOUSING

82 FEMALE-SIDE CYLINDER PORTION

823 GUIDE GROOVE

824 ELASTIC PIECE

824a FREE END

824b FIXED END

825 PROTRUSION

829 FRAME PORTION

829a TO 829c FACE

829D OPENING

84 FEMALE-SIDE CONVEX PORTION

86 BOLT

90 ELECTRIC POWER CABLE

91 ELECTRIC WIRE

92 INSULATING LAYER

93 BRAIDED WIRE

1. A connector assembly comprising:
a first connector including a first terminal, a first connector main body which holds the first terminal, and a bolt which is held to be rotatable by the first connector main body;
a second connector including a second terminal which can be fitted with the first terminal, a second connector main body which holds the second terminal and can be fitted with the first connector main body, and a female screw portion which is provided in the second connector main body; and
a fitting indicator which indicates fitting between the first terminal and the second terminal,
wherein the first connector and the second connector fit together by screwing the bolt and the female screw portion with each other, and
the fitting indicator includes:
an elastic piece which has a protrusion and which is provided in one of the first connector main body or the second connector main body along a fitting direction of the first terminal and the second terminal; and
a concave portion which is provided in other of the second connector main body or the first connector main body and into which the protrusion is inserted.

2. The connector assembly according to claim 1, wherein
the bolt is held to be rotatable by the first connector main body at a position deviated from the center of the first connector, and
the female screw portion is also provided in the second connector main body at a position deviated from the center of the second connector so as to correspond to the bolt.

3. The connector assembly according to claim 1, wherein
the fitting indicator indicates fitting between the first terminal and the second terminal on the basis of a relative positional relation between the first connector main body and the second connector main body.

4. The connector assembly according to claim 1, wherein
the other of the second connector main body or the first connector main body includes a rib extending along the fitting direction, and
the concave portion is formed in the rib.

5. The connector assembly according to claim 4, wherein
when the first connector main body and the second connector main body start to fit together, the elastic piece is bent by being pressed by the rib, and
when a relative position between the first connector main body and the second connector main body arrives at a position where the first terminal and the second terminal fit together at a regular position, the protrusion is inserted into the concave portion, and the bending of the elastic piece is released.

6. The connector assembly according to claim 1, wherein
the one of the first connector main body or the second connector main body includes a frame portion which surrounds at least a part of the elastic piece.
